(19) United States
(12) Patent Application Publication
(10) Pub. No.: US 2017/0272265 A1
(43) Pub. Date: Sep. 21, 2017

(54) INFORMATION PROCESSING APPARATUS, SYSTEM, AND INFORMATION PROCESSING METHOD

(71) Applicant: Atsushi OKAZATO, Kanagawa (JP)

(72) Inventor: Atsushi OKAZATO, Kanagawa (JP)

(73) Assignee: RICOH COMPANY, LTD., Tokyo (JP)

(21) Appl. No.: 15/459,098

(22) Filed: Mar. 15, 2017

(30) Foreign Application Priority Data
Mar. 17, 2016 (JP) 2016-053576

(51) Int. Cl. H04L 12/18; G06F 3/147; G06F 3/14

(52) U.S. Cl. CPC H04L 12/1831; G06F 3/1454; G06F 3/147

(57) ABSTRACT

An information processing apparatus is connected with a plurality of information terminals, and includes processing circuitry. The processing circuitry is to extract at least shared information from history information transmitted from a first information terminal included in the plurality of information terminals, the shared information being shared among at least two of the plurality of information terminals; generate display information for displaying the extracted shared information; and transmit the display information to at least one of the information terminals.

### CROSS-REFERENCE TO RELATED APPLICATIONS

The present application claims priority under 35 U.S.C. §119 to Japanese Patent Application No. 2016-053576, filed on Mar. 17, 2016. The contents of which are incorporated herein by reference in their entirety.

### 1. FIELD OF THE INVENTION

The present invention relates to an information processing apparatus, a system, and an information processing method.

### 2. DESCRIPTION OF THE RELATED ART

A remote conference system in which a plurality of sites is connected to implement remote cooperative operations has been known. For example, Japanese Unexamined Patent Application Publication No. 2004-171526 proposes a technique for storing files generated as a result of a conference, reference information related to the conference, history information about accesses to the files performed by attendances of the conference, and the like by using site systems installed in sites and a shared work space server which interconnects the systems.

Moreover, a secure conference system has been known, in which conference materials are shared with conference attendances only while the conference is held and no information remains after the conference is closed. In the conference system described above, it is desired that conference materials shared in conferences held in the past are temporarily shared in a currently held conference.

However, in conventional conference systems, a problem may arise such that it takes time to identify the materials to be shared in a currently held conference from among the materials shared in past conferences. Accordingly, in some cases, it may take a long time for interrupting the conference, for example.

### SUMMARY OF THE INVENTION

According to one aspect of the present invention, an information processing apparatus is connected with a plurality of information terminals, and includes processing circuitry. The processing circuitry is to extract at least shared information from history information transmitted from a first information terminal included in the plurality of information terminals, the shared information being shared among at least two of the plurality of information terminals; generate display information for displaying the extracted shared information; and transmit the display information to at least one of the information terminals.

### BRIEF DESCRIPTION OF THE DRAWINGS

FIG. 1 is a view which illustrates an example of a configuration of a system;

FIG. 2 is a view which illustrates an example of a hardware configuration of an information processing server;

FIG. 3 is a view which illustrates an example of functions of the information processing server;

FIG. 4 is a view which illustrates an example of a data structure of conference information;

FIG. 5 is a view which illustrates an example of a data structure of image data;

FIG. 6 is a view which illustrates an example of a folder structure of the image data;

FIG. 7 is a view which illustrates an example of a data structure of operation history information;

FIG. 8 is a view which illustrates an example of a data structure of conference history information;

FIG. 9 is a view which illustrates an example of a data structure of a file for analysis;

FIG. 10 is a view which illustrates an example of a hardware configuration of an information terminal;

FIG. 11 is a view which illustrates an example of functions included in the information terminal;

FIG. 12 is a view which illustrates an example of functions provided by a client application;

FIG. 13 is a sequence diagram which illustrates an example of display processing;

FIG. 14 is a view which illustrates an example of a conference operation screen;

FIG. 15 is a view which illustrates an example of a conference history transfer screen;

FIG. 16 is a view which illustrates an example of a “Transferring Conference Information” message display screen;

FIG. 17 is a view which illustrates an example of a conference history list screen;

FIG. 18 is a view which illustrates an example of a rerun confirmation screen;

FIG. 19 is a view which illustrates an example of an operation selection screen;

FIG. 20 is a view which illustrates an example of a “operation being rerun” message display screen;

FIG. 21 is a view which illustrates an example of a conference history list screen;

FIG. 22 is a sequence diagram which illustrates an example of rerun processing;

FIG. 23 is a sequence diagram which illustrates an example of conference closing processing;

FIG. 24 is a flow chart which illustrates an example of conference history generation processing;

FIG. 25 is a flow chart which illustrates an example of conference history development processing;

FIG. 26 is a flow chart which illustrates an example of conference history analysis processing;

FIG. 27 is a view which illustrates an example of a folder structure after the conference history development processing;

FIG. 28 is a view which illustrates an example of a folder structure after conference history list screen is generated;

FIG. 29 is a view which illustrates an example of a folder structure after the past operation history is rerun;

FIG. 30 is a view which illustrates an example of a hardware configuration of a projector;

FIG. 31 is a view which illustrates an example of a hardware configuration of an electronic whiteboard; and

FIG. 32 is a view which illustrates an example of a hardware configuration of a multifunction peripheral (MFP).

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to provide an information processing apparatus, a system, an information processing method, and a program capable of easily identifying information to be shared.

A case will be described below in which the system according to the present invention is applied to a conference system. The applicable system is not limited to a conference system, and the system may be applied to another system in which information is shared among a plurality of information terminals, for example.

As described above, it is desired that shared information (e.g., conference materials or the like) shared in previously held conferences are temporarily shared in a subsequently held conference. Information shared in past conferences is stored on an information terminal used by a user who has hosted the past conferences (conference host), for example. Conventionally, it is not easy to identify desired information to be shared from among the stored shared information.

In the present embodiment, past conference history information (an example of history information) transferred from an information terminal is analyzed and shared information obtained by the analysis is displayed selectively to the user such as a conference host. It is thus enabled to reduce the time taken for identifying the shared information to be shared in a currently held conference from among past shared information, and as a result, it is also enabled to reduce the conference interruption time, for example.

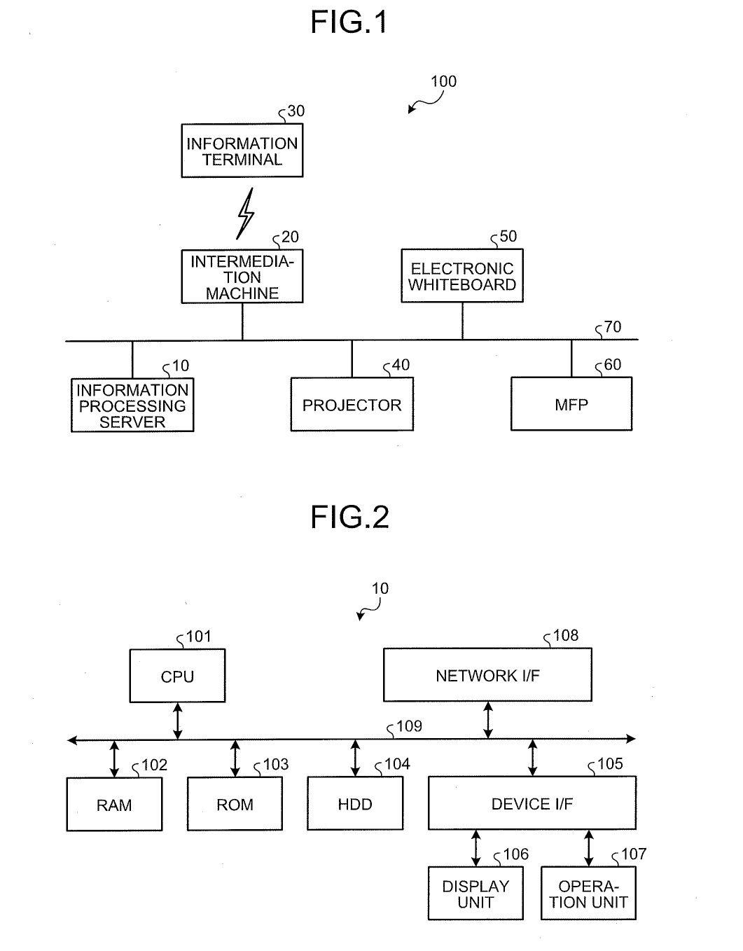

FIG. 1 is a view which illustrates an example of configuration of a system 100 according to the present embodiment. The system 100 of the present embodiment is constructed as a network conference system that operates in a logically closed environment. Referring to FIG. 1, the system 100 includes an information processing server 10, an intermediation machine 20, an information terminal 30, a projector 40, an electronic whiteboard 50, and an MFP 60. The information processing server 10, the intermediation machine 20, the projector 40, the electronic whiteboard 50, and the MFP 60 are connected via a network 70 for conference (hereinafter simply referred to as the “network 70”). The intermediation machine 20 is an access point, for example, and the range of reachable radio waves from the intermediation machine 20 may be herein referred to as a “barrier”. The intermediation machine 20 is intermediation means for connecting the information terminal 30 existing inside the barrier (i.e., the information terminal 30 used by a conference attendance) to the network 70 by using a wireless communication technique such as Bluetooth (registered trademark) and Wi-Fi (registered trademark). In FIG. 1, one information terminal 30 is illustrated as an example for easier understanding, but the present embodiment is not limited to this and an arbitrary number of the information terminals 30 may be connected to the network 70 via the intermediation machine 20. In addition, in an example illustrated in FIG. 1, the system 100 includes devices such as the projector 40, the electronic whiteboard 50, and the MFP 60. However, the present embodiment is not limited to this configuration and the types and the number of the devices included in the system 100 can be arbitrarily changed. Specifically, the system 100 may be configured so as to include one or more devices that implement processing of data received from the information processing server 10.

The information processing server 10 is an example of the information processing apparatus and performs management of the entire conference, management of data (storage, deletion, and the like), control of output to the devices (the projector 40, the electronic whiteboard 50, the MFP 60, etc.), and the like. FIG. 2 is a view which illustrates an example of a hardware configuration of the information processing server 10. Referring to FIG. 2, the information processing server 10 includes a central processing unit (CPU) 101, a random access memory (RAM) 102, a read only memory (ROM) 103, a hard disk drive (HDD) 104, a device interface (I/F) 105, a network I/F 108, which are interconnected via a bus 109. In addition, a display unit 106 and an operation unit 107 are connected to the device I/F 105.

The CPU 101 is computation means which controls respective operations of the entire information processing server 10. The RAM 102 is a high-speed random access volatile storage medium, which is used by the CPU 101 as a work area for processing information. The ROM 103 is a read-only non-volatile storage medium which stores a program such as firmware. The HDD 104 is a random access nonvolatile storage medium, which stores an operating system (OS) and various programs such as a control program and application programs.

The device I/F 105 is an interface for connecting each of the display unit 106 and the operation unit 107 to the bus 109. The display unit 106 is a visual user interface for displaying various information, and is constituted by a liquid crystal display (LCD), for example. The operation unit 107 is a user interface such as a keyboard and a mouse, which is used by a user to input various information to the information processing server 10. The network I/F 108 is an interface for connecting the information processing server 10 to the network 70. The network I/F 108 may be an interface compliant with a conventionally used arbitrary method, such as an Ethernet (registered trademark) interface, for example.

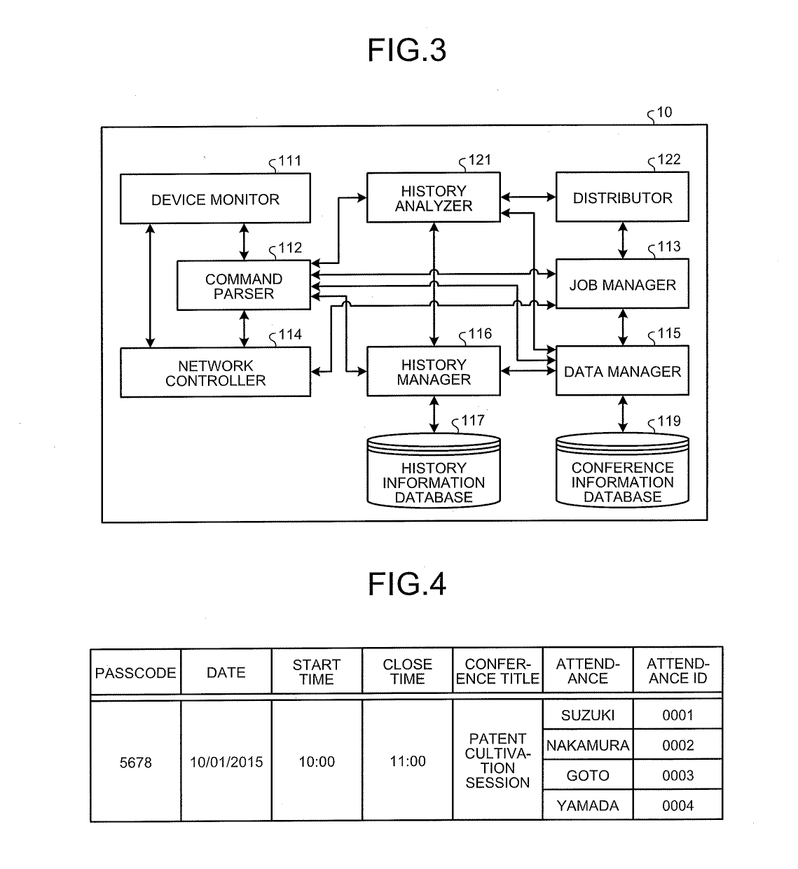

FIG. 3 is a view which illustrates an example of functions included in the information processing server 10. In FIG. 3, functions related to the present embodiment are primarily illustrated as examples for easier understanding. However, functions included in the information processing server 10 are not limited to them. Referring to FIG. 3, the information processing server 10 includes a device monitor 111, a command parser 112, a job manager 113, a network controller 114, a data manager 115, a history manager 116, a history information database 117, a conference information database 119, a history analyzer 121, and a distributor 122.

The device monitor 111 monitors other devices connected to the network 70 and statuses thereof to manage available functions. The command parser 112 parses a command instruction (as described below) received from the information terminal 30, collates the received instruction with a function managed by the device monitor 111 (available function), and notifies content of processing by other devices to the job manager 113. In addition, the command parser 112 receives information about a conference (conference information) such as production and editing of conference start time and conference close time and attendance to and leaving from the conference and requests updating of the conference information to the data manager 115. Further, the command parser 112 is capable of requesting acquisition of operation history information to the history manager 116.

The job manager 113 generates (constructs) a job for other devices based on the content of notification from the command parser 112, transmits the generated job via the network controller 114, and receives job responses. Image data acquired by receiving the job response is transferred to the data manager 115. The network controller 114 controls transmission and reception of information to and from external apparatuses via the network I/F 108 illustrated in FIG. 2.

The data manager 115 stores the conference information received from the command parser 112 and the image data received from the job manager 113 in the conference information database 119. In this example, the conference information database 119 centrally controls data of materials used in the conference (such as image data) and can be constituted by the HDD 104, for example. In addition, the data manager 115 acquires conference information and image data from the conference information database 119 upon request from the command parser 112 and the job manager 113 and provides them with the acquired information and data. The data manager 115 also generates operation history information and transfers the generated information to the history manager 116. For example, the data manager 115 generates operation history information and transfers the generated information to the history manager 116 every time the conference information or the image data acquired by receiving the job response is stored. Content of the operation history information will be specifically described below.

FIG. 4 is a view which illustrates an example of a data structure of the conference information. Referring to FIG. 4, the conference information includes passcode, date, start time, closing time, conference title, attendances, and attendance identification (ID). The passcode is information for identifying the conference information. The date, the start time, and the closing time denote the date on which the conference is held and the start time and the closing time of the conference. The attendance ID is information for identifying each attendance, which is assigned at the time of start of the conference.

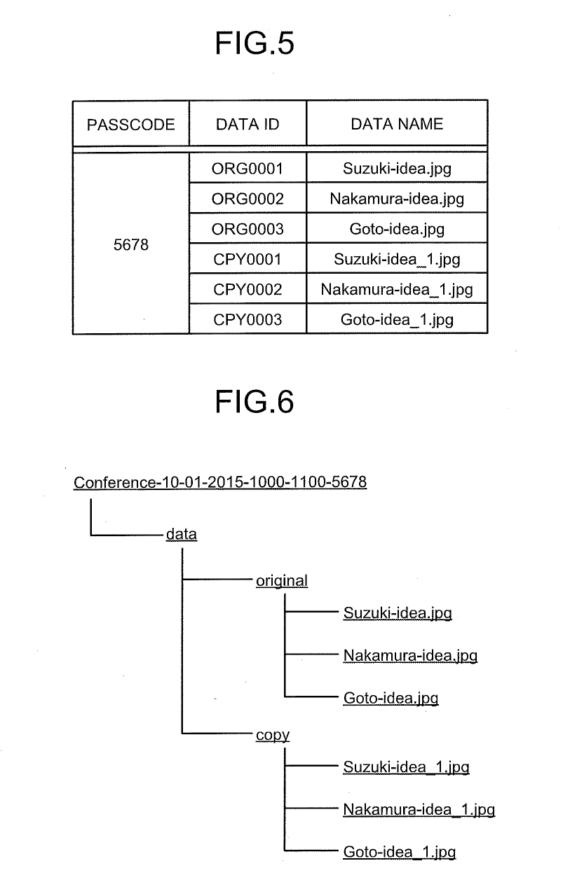

FIG. 5 is a view which illustrates an example of a data structure of image data. FIG. 6 is a view which illustrates an example of a folder structure of image data. The image data is an example of data of a material used in the conference, i.e., shared information. The shared information may include data other than image data.

Referring to FIG. 5, the image data includes passcode, data ID, and data name. The data ID is information for identifying the image data. For example, the data ID is assigned in such a manner that the prefix “ORG” is assigned to a file that has been already registered at the start of the conference. In addition, the data ID is assigned in such a manner that the prefix “CPY” is assigned to a file generated by capturing an image from the electronic whiteboard 50 during the conference, for example.

Referring to FIG. 6, the image data is recorded in a subfolder such as “original” subfolder and “copy” subfolder that has been separately created under a “data” folder among folders generated according to a naming rule “conference-[month]-[day]-[year]-[start time]-[closing time]-[passcode]”, for example.

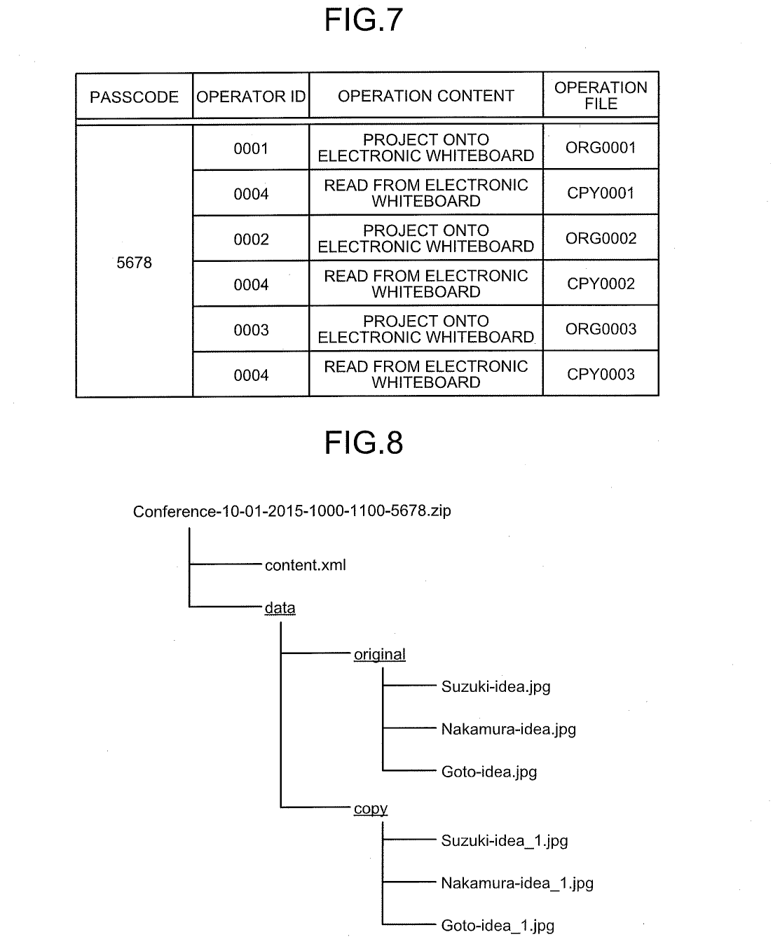

FIG. 7 is a view which illustrates an example of a data structure of the operation history information. Referring to FIG. 7, the operation history information includes passcode, an operator ID, operation content, and operation file. For the operator ID, the same number as that assigned as the attendance ID is used. More specifically, the attendance ID of an attendance who carried out a corresponding operation, among the attendances, is set as the operator ID.

Returning to FIG. 3, the history manager 116 stores (records) the operation history information generated by the data manager 115 in the history information database 117. The history information database 117 may be constituted by the HDD 104, for example. In addition, the history manager 116 acquires operation history information from the history information database 117 upon request from the command parser 112.

The history analyzer 121 analyzes the conference information transferred to the information processing server 10 upon request from the command parser 112. The conference history information is information which indicates history of a past conference. The conference history information includes shared information shared among at least two of a plurality of information terminals 30 included in the system for past conferences, conference information about a conference in which the shared information has been shared, and operation history information, for example. To the history analyzer 121, conference history information having been designated to be transferred from the information terminal 30 among conference history information for past conferences stored in the information terminal 30, for example, is input. For example, the history analyzer 121 extracts at least shared information from the conference history information, and may referred to as an extractor. The history analyzer 121 may analyze conference history information and further extract conference information and image data.

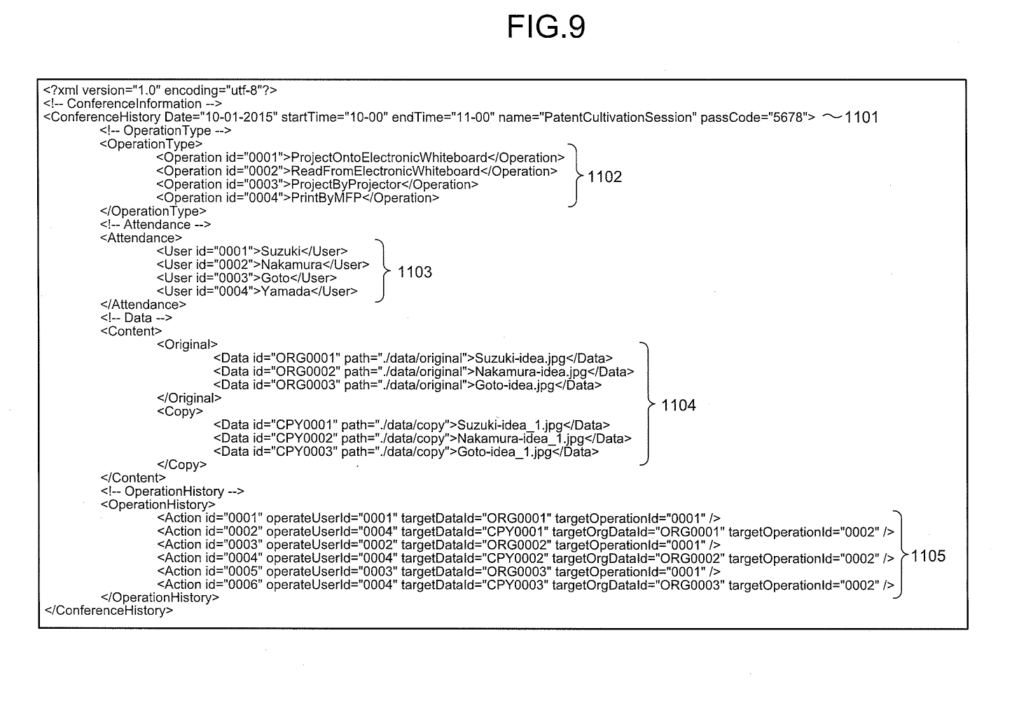

FIG. 8 is a view which illustrates an example of a data structure of the conference history information. Referring to FIG. 8, the conference history information includes a file (content.xml) used for analyzing conference history information and image data. The file used for analysis will be described in detail with reference to FIG. 9.

The conference history information is generated by the history analyzer 121 at the closure of the conference and transmitted to the information terminal 30 used by the conference host. In FIG. 8, an example is illustrated in which the conference history information is in a compressed file format generated according to a naming rule “conference-[month]-[day]-[year]-[start time]-[closing time]-[passcode].zip”. The compression file format is not limited to the zip format and any file format may be applied. For example, a format in which the file is compressed with a password so that the file may be decompressed only within the information processing server 10.

FIG. 9 is a view which illustrates an example of a data structure of the file used for analyzing conference history information (file for analysis) illustrated in FIG. 8. For example, at the closure of the conference, the history analyzer 121 refers to the conference information database 119 and the history information database 117 to generate a file for analysis.

Referring to FIG. 9, the file for analysis includes conference information 1101, operation type 1102, attendance 1103, data 1104, and operation history 1105. The operation type 1102 includes an operation uniquely defined in the information processing server 10 and a corresponding operation ID.

The attendance 1103 includes conference attendance information stored in the conference information database 119 and a corresponding attendance ID. The data 1104 includes image data stored in the conference information database 119 and a corresponding data ID.

The operation history 1105 is generated by combining the data stored in the conference information database 119 and the data stored in the history information database 117. For example, information including Action id=“0001” indicates a history of an operation in which an operator (Suzuki) with Operator ID=“0001” has projected data “Suzuki-idea.jpg” with data ID=“ORG0001” onto the electronic whiteboard 50. The attendance (Suzuki) has attendance ID (User id)=“0001”, and thus the operator ID in the operation history(=operateUserId) is “0001”. Similarly, because the operation file (=targetDataId) is “Suzuki-idea.jpg”, the data on the data history (Data id) is “ORG0001”. The operation content is projection onto the electronic whiteboard 50, and thus the operation content (=Operation id) is “0001” based on the definition value for the operation type.

Returning to FIG. 3, the distributor 122 generates display information for displaying the extracted shared information (functioning as a generator) and transmits the generated display information to the information terminal 30 (functioning as a transmitter). For example, the distributor 122 receives history information, conference information, and image data from the history analyzer 121 and generates a web page (an example of the display information) which can be displayed from the information terminal 30 (for example, a client application 215 described below). In addition, the distributor 122 receives content including compressed history information, conference information, and image data from the history analyzer 121 and generates a web page that can be downloaded from the information terminal 30. The distributor 122 includes a web server function which enables transmission of the web page.

Moreover, the functions included in the information processing server 10 described above (the device monitor 111, the command parser 112, the job manager 113, the network controller 114, the data manager 115, the history manager 116, the history analyzer 121, and the distributor 122) can be implemented by the CPU 101 by executing a program from the ROM 103 or the like, for example. At least a part of the functions included in the information processing server 10 may be constituted by a hardware circuit.

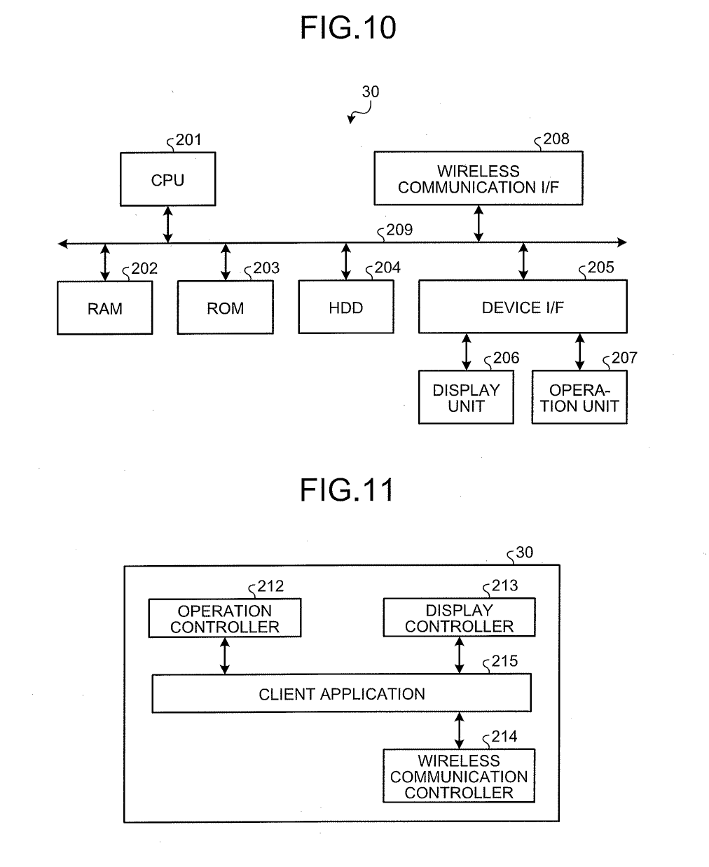

FIG. 10 is a view which illustrates an example of a hardware configuration of the information terminal 30. The information terminal 30 is constituted by a multifunction mobile device (smart device) such as a smart phone or a tablet, for example. Referring to FIG. 10, the information terminal 30 includes a CPU 201, a RAM 202, a ROM 203, an HDD 204, a device I/F 205, and a wireless communication I/F 208, which are interconnected via a bus 209. In addition, a display unit 206 and an operation unit 207 are connected to the device I/F 205.

The CPU 201 is computation means which controls respective operations of the entire information terminal 30. The RAM 202 is a high-speed random access volatile storage medium, which is used by the CPU 201 as a work area for processing information. The ROM 203 is a read-only non-volatile storage medium which stores a program such as firmware. The HDD 204 is a random access nonvolatile storage medium, which stores an OS and various programs such as a control program and application programs.

The device I/F 205 is an interface for connecting each of the display unit 206 and the operation unit 207 to the bus 209. The display unit 206 is a visual user interface for displaying various information, and is constituted by an LCD, for example. The operation unit 207 is a user interface such as a keyboard and a mouse, which is used by a user to input various information to the information terminal 30. The wireless communication I/F 208 is an interface for the information terminal 30 for performing wireless communication with the intermediation machine 20.

FIG. 11 is a view which illustrates an example of functions included in the information terminal 30 (functions executed by the CPU 201 of the information terminal 30). In FIG. 11, functions related to the present embodiment are primarily illustrated as examples for easier understanding. However, functions included in the information terminal 30 are not limited to them. Referring to FIG. 11, the information terminal 30 includes an operation controller 212, a display controller 213, a wireless communication controller 214, and a client application 215. The operation controller 212 receives an operation signal input via the operation unit 207 and inputs the received signal to modules operating on the information terminal 30, such as the client application 215. It can also be assumed that the operation controller 212 has a function for receiving a user operation. The display controller 213 performs control for displaying various information about the information terminal 30 such as a graphic user interface (GUI) of the client application 215 on the display unit 206. The wireless communication controller 214 controls communication with other devices via the wireless communication I/F 208. For example, the wireless communication controller 214 acquires information input via the wireless communication I/F 208 and transmits information to be transmitted to other devices via the wireless communication I/F 208.

The client application 215 is a software module which provides various functions of the information terminal 30 and is constituted by software programs corresponding to respective functions. Dedicated applications for using the conference system according to the present embodiment are also included in the client application 215.

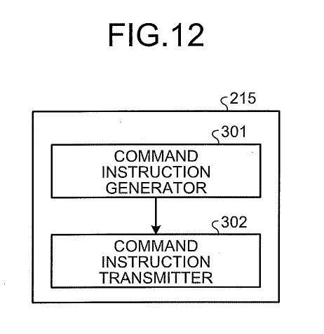

FIG. 12 is a view which illustrates an example of functions provided by the client application 215. In FIG. 12, functions related to the present embodiment only are illustrated as examples for easier understanding. However, functions provided by the client application 215 are not limited to them. Referring to FIG. 12, the client application 215 includes a command instruction generator 301 and a command instruction transmitter 302.

The command instruction generator 301 generates a command instruction according to a user operation received via various screens, which will be described below. Content of the command instruction will be described below. The command instruction transmitter 302 transmits the command instruction generated by the command instruction generator 301 to the information processing server 10 via the intermediation machine 20. After receiving the command instruction, the information processing server 10 generates a job based on the received command instruction. Then the information processing server 10 transmits the generated job to a target device and records history information based on a job response received from the device.

The functions included in the information terminal 30 described above are implemented by the CPU 201 by executing a program from the ROM 203. However, the functions of the information terminal 30 are not limited to them. For example, at least a part of the functions included in the information terminal 30 described above may be constituted by a hardware circuit.

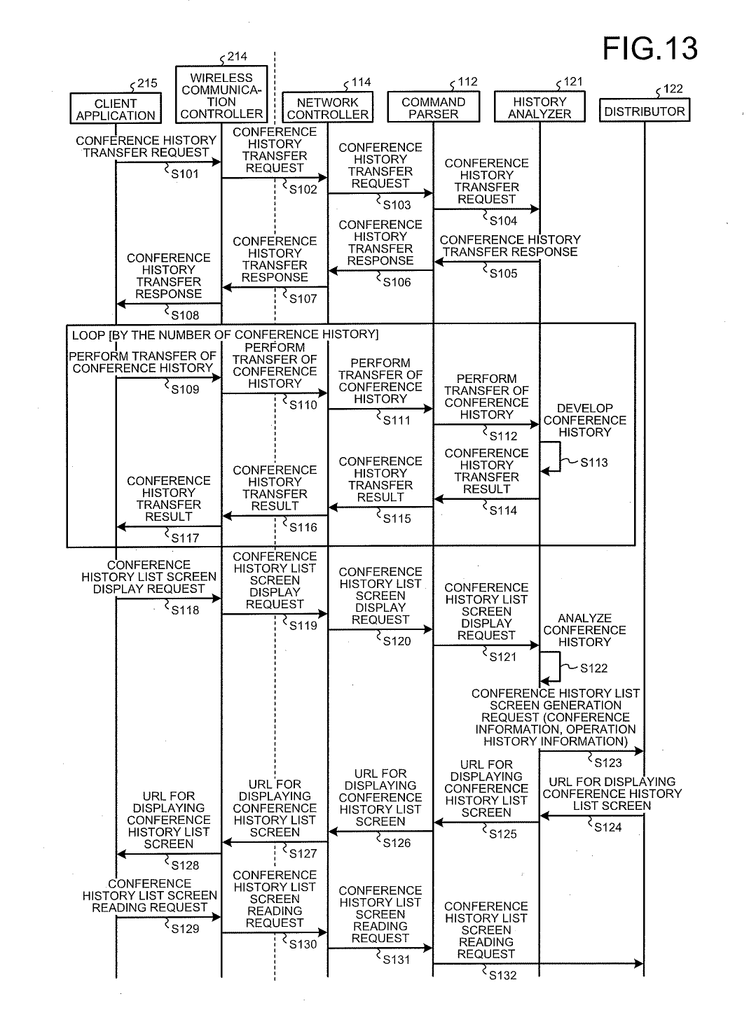

Next, display processing by the system according to the present embodiment having the above-described configuration will be described with reference to FIG. 13. FIG. 13 is a sequence diagram which illustrates an example of the display processing according to the present embodiment. The display processing is processing for displaying information based on history information about past conferences, which is stored in the information terminal 30 used by a conference host, on the information terminal 30.

The client application 215 of the information terminal 30 issues a conference history transfer request to the information processing server 10 (step S101). The conference history transfer request is transmitted to the history analyzer 121 via the wireless communication controller 214 of the information terminal 30 and the network controller 114 and the command parser 112 of the information processing server 10 (steps S102 to S104).

The history analyzer 121 transmits a response to the request (conference history transfer response) to the client application 215 via the command parser 112, the network controller 114, and the wireless communication controller 214 (steps S105 to S108). The response includes information which indicates whether to permit transfer of the conference history information, for example. The history analyzer 121 may determine whether the information terminal 30 that is the request transmission source (or the user of the information terminal 30) has been authorized for the transfer, so that a response for permitting the transfer is returned if the information terminal 30 (or the user of the information terminal 30) has been authorized, and a response for not permitting the transfer is returned if the information terminal 30 (or the user of the information terminal 30) has not been authorized.

If the transfer has not been permitted, the client application 215 outputs a notification which notifies that the transfer has not been permitted, for example, and does not perform the following processing. If the transfer has been permitted, the following processing by steps S109 to S117 is performed for times equivalent to the number of pieces of the conference history information.

More specifically, the client application 215 transfers the conference history information stored in the information terminal 30 to the history analyzer 121 via the wireless communication controller 214, the network controller 114, and the command parser 112 (steps S109 to S112). The history analyzer 121 develops the transferred conference history information onto a temporary work area, for example (step S113). The history analyzer 121 transmits the result of the transfer processing to the client application 215 via the command parser 112, the network controller 114, and the wireless communication controller 214 (steps S114 to S117).

After all the pieces of conference history information have been completely transferred, the client application 215 requests display of a conference history list screen to the information processing server 10 (step S118). The conference history list screen will be described in detail later below. The display request is transmitted to the history analyzer 121 via the wireless communication controller 214, the network controller 114, and the command parser 112 (steps S119 to S121).

The history analyzer 121 receives the display request and analyzes the conference history information (step S122). The analysis processing by the history analyzer 121 will be described in detail later below. After the analysis processing, the history analyzer 121 requests generation of the conference history list screen to the distributor 122 (step S123). The distributor 122 generates a web page for displaying the conference history list screen (an example of display information) by using the conference information and image data extracted by the analysis processing and operation history information. In addition, the distributor 122 arranges the generated web page so that the web page can be distributed by the web server function. The distributor 122 also transmits address information (uniform resource locator (URL)) for displaying the conference history list screen to the client application 215 via the history analyzer 121, the command parser 112, the network controller 114, and the wireless communication controller 214 (steps S124 to S128).

The client application 215 requests reading of the conference history list screen by using the transmitted URL (step S129). The reading request is transmitted to the distributor 122 via the wireless communication controller 214, the network controller 114, and the command parser 112 (steps S130 to S132). Then the web page transmitted from the distributor 122 is displayed on the information terminal 30.

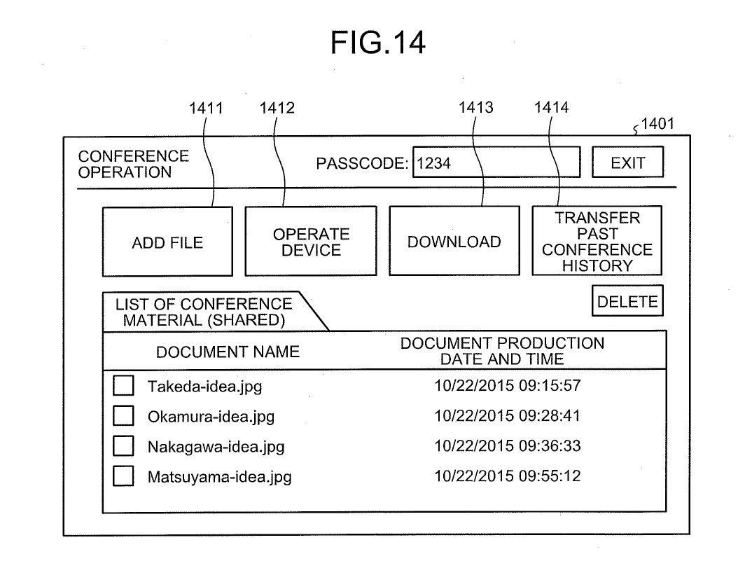

Next, examples of various screens displayed by the present embodiment will be described. Each screen is generated by the distributor 122 which functions as a generator. FIG. 14 is a view which illustrates an example of the conference operation screen. The conference operation screen is a screen for designating various operations that can be performed during a conference.

Referring to FIG. 14, the conference operation screen 1401 includes buttons 1411 to 1414. The conference attendances can perform various operations corresponding to the buttons 1411 to 1414 via the conference operation screen. The conference materials can be verified in a “conference material list (currently shared)” tab. In this tab, a list of the conference materials shared in the current conference can be verified.

The button 1411 (“Add File”) is used to upload the materials stored in the information terminal 30 that is currently operated by the user to the information processing server 10 to share them. The button 1412 (“Operate Device”) is used for projecting the currently shared conference material onto the electronic whiteboard 50 or the projector 40 or for printing it by the MFP 60. The button 1413 (“Download”) is used to download the currently shared conference materials to the information terminal 30 that is currently operated by the user. The button 1414 (“Transfer Past History Conference”) is used to temporarily share the conference materials used in past conferences in the current conference.

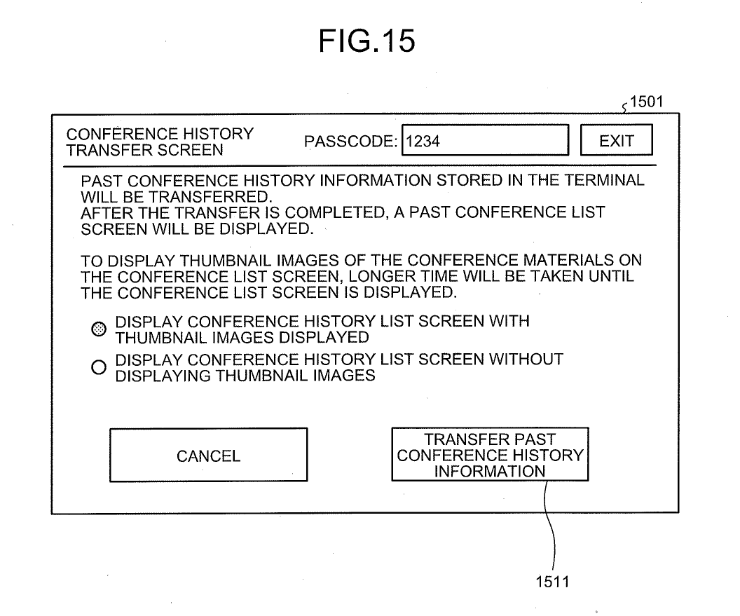

FIG. 15 is a view which illustrates an example of a conference history transfer screen. A conference history transfer screen 1501 is a screen displayed when the button 1414 (“Transfer Past History Conference”) is pressed via the conference operation screen 1401.

The conference host can transfer past conference history information stored in the currently operated information terminal 30 to the information processing server 10 by pressing a button 1511 (“Transfer Past Conference History Information”) via the conference history transfer screen 1501. The display processing illustrated in FIG. 13 is started with the pressing of the button 1511, for example, as the trigger.

In the example illustrated in FIG. 15, the user is enabled to select between displaying the conference history list screen with thumbnail images being displayed and displaying it without displaying thumbnail images. More specifically, the conference history list screen is a screen for displaying a list of conference history generated by the information processing server 10 based on the transferred conference history information. The user who is allowed to transfer the conference history information to the information processing server 10 is not limited to the conference host, and a configuration can be employed in which other conference attendances are allowed to designate transfer of conference history information.

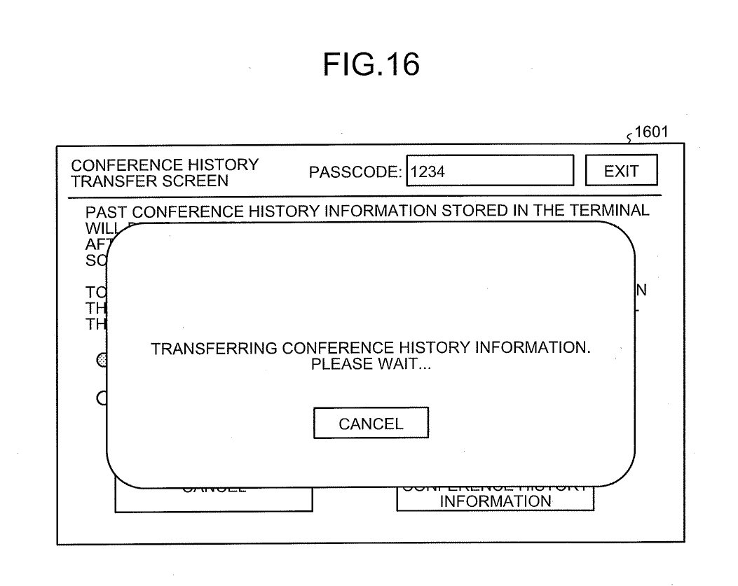

FIG. 16 is a view which illustrates an example of a “Transferring Conference Information” message display screen. A “Transferring Conference Information” message display screen 1601 is a screen displayed if the button 1511 (“Transfer Past Conference History Information”) is pressed via the conference history transfer screen 1501. While the “Transferring Conference Information” message display screen 1601 is being displayed, past conference history information stored in the information terminal 30 used by the conference host is transferred to the information processing server 10.

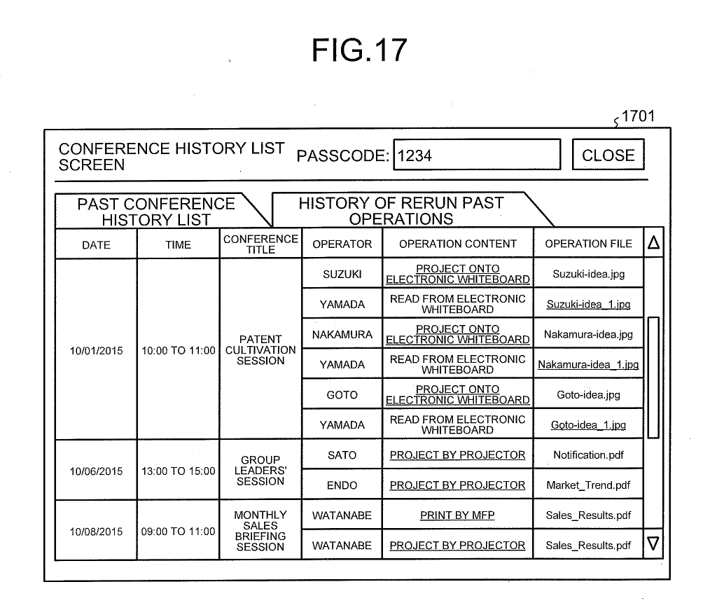

FIG. 17 is a view which illustrates an example of the conference history list screen. A conference history list screen 1701 is a screen displayed if the “Transferring Conference Information” message display screen 1601 is displayed after the transfer of the past conference history information is completed. Referring to FIG. 17, the conference history list screen 1701 includes a “Past Conference History List” tab and a “History of Rerun Past Operations” tab. The conference history list screen 1701 is an example of a screen displayed when the “Past Conference History List” tab has been selected. An example of the conference history list screen 1701 which is displayed when the “History of Rerun Past Operations” tab is selected will be described later below. On the conference history list screen 1701, conference history is sorted in order of date and time of past conference and displayed as a list.

As described above, in the present embodiment, the distributor 122 generates display information (the conference history list screen) for displaying the shared information (the operation file) and the generated display information is displayed by the client application 215. With the above-described configuration, the user is enabled to easily identify the shared information to be shared in the current conference from among the past shared information.

If the screen is pressed at a character string displayed in the operation content column as an underlined character string, it is enabled to rerun an operation that has been performed in the past. For example, when the character string “Project onto Electronic Whiteboard” displayed in the screen is pressed, a rerun confirmation screen for asking the user for confirmation as to whether to rerun the corresponding operation is displayed, and then image data displayed in the operation file column is projected onto the electronic whiteboard 50.

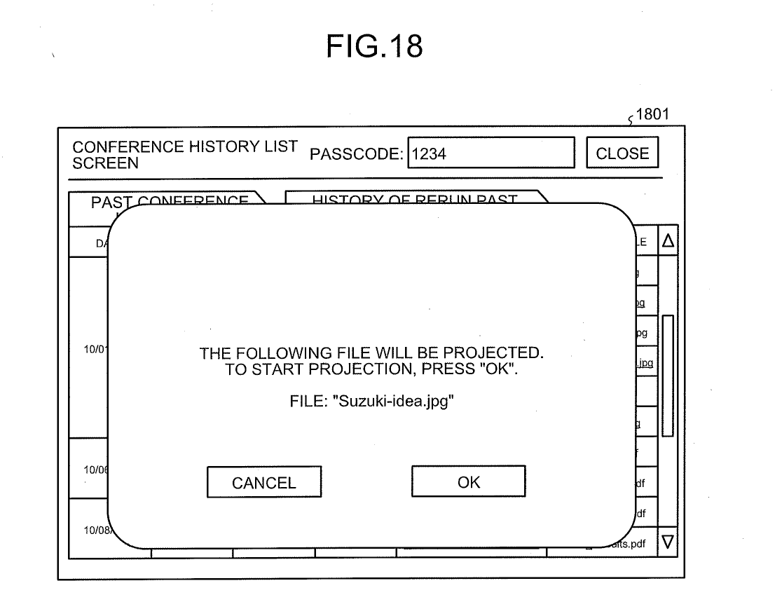

FIG. 18 is a view which illustrates an example of the rerun confirmation screen. A rerun confirmation screen 1801 is a screen displayed when a character string displayed as a underlined text in the operation content column in the conference history list screen 1701 is pressed. In FIG. 18, an example is illustrated that askes the user for confirmation as to whether to project the corresponding image data to the electronic whiteboard 50 when the character string displayed in the first cell of the operation content column illustrated in FIG. 17 (“Project to Electronic Whiteboard”) is pressed.

Returning to FIG. 17, when the character string displayed as an underlined character string in the operation file column in the screen is pressed, an operation selection screen is displayed, which displays a list of executable operations from which the user is allowed to select one.

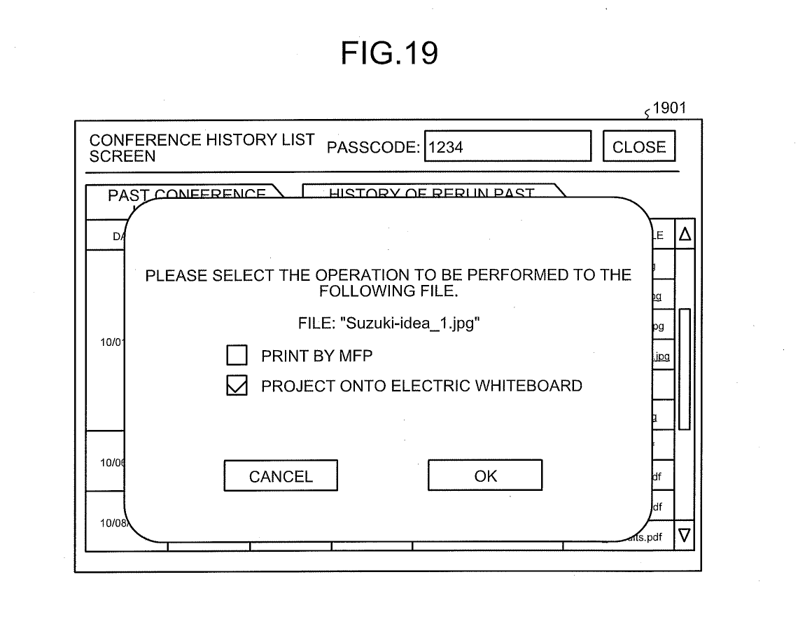

FIG. 19 is a view which illustrates an example of the operation selection screen. An operation selection screen 1901 is a screen displayed when an underlined character string displayed in the operation file column of the conference history list screen 1701 (e.g., “Suzuki-idea_1.jpg”) is selected. On the operation selection screen, alternatives for operation of devices provided from the information processing server 10 are displayed. In the example illustrated in FIG. 19, two alternatives including “Print by MFP” “Project to Electronic Whiteboard” are displayed. The user can select a desired operation from among these alternatives and execute the selected operation.

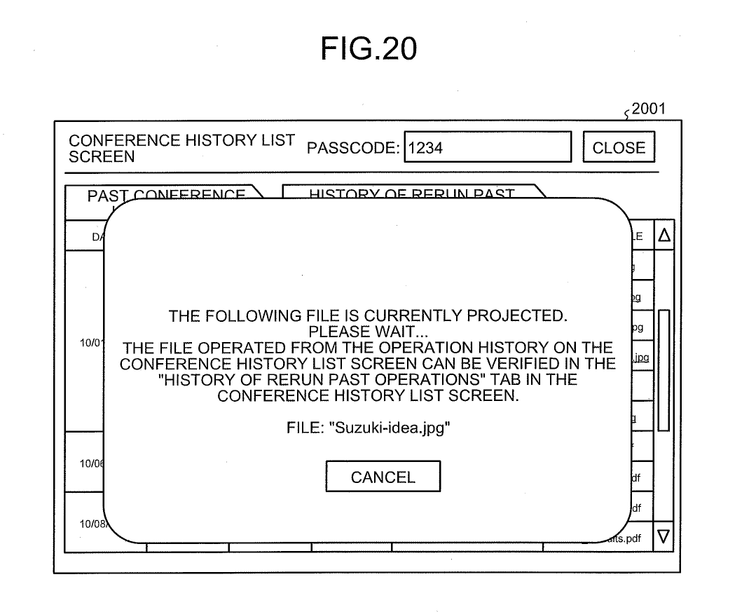

FIG. 20 is a view which illustrates an example of a “Rerunning Operation” message display screen. A “Rerunning Operation” message display screen 2001 is a screen displayed when the “Execute” button is pressed via the rerun confirmation screen 1801. In the example illustrated in FIG. 20, the “Rerunning Operation” message display screen 2001 disappears when projection of the operation file “Suzuki-idea.jpg” to the electronic whiteboard 50 is completed.

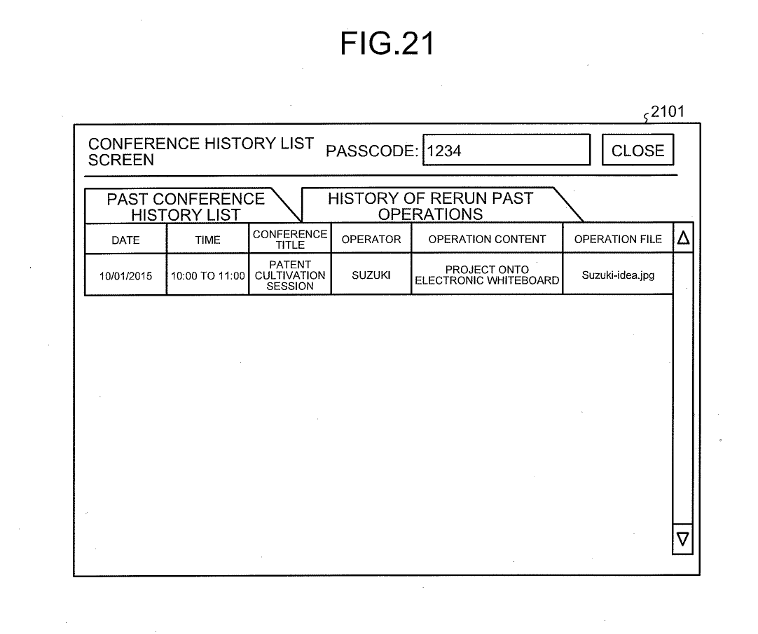

FIG. 21 is a view which illustrates an example of the conference history list screen displayed when the “History of Rerun Past Operations” is selected. A conference history list screen 2101 is a screen for verifying the history of rerun operations. The conference history list screen 2101 is an example of a screen displayed after projection of the operation file “Suzuki-idea.jpg” illustrated in FIG. 20 to the electronic whiteboard 50 is completed. The past operation history is displayed as a list in descending order of rerun timings.

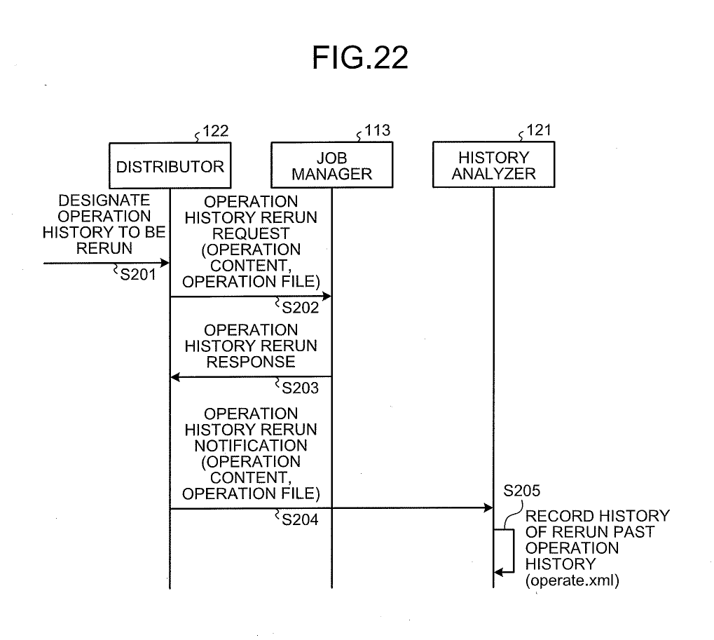

Next, the operation history rerun processing will be described below. FIG. 22 is a sequence diagram which illustrates an example of the rerun processing.

For example, when rerunning of an operation history is designated via the rerun confirmation screen 1801 illustrated in FIG. 18, the distributor 122 of the information processing server 10 receives a request including information about the operation history to be rerun (step S201). The distributor 122 issues a request for rerunning the operation history to the job manager 113 (step S202). The request includes an operation to be rerun (operation content) and data to be operated (operation file). For example, when the file “Suzuki-idea.jpg” is designated in the conference history list screen 1701 illustrated in FIG. 17 to be rerun, the distributor 122 issues a request for projecting the file “Suzuki-idea.jpg” onto the electronic whiteboard 50 to the job manager 113. The job manager 113 reruns the designated operation according to the request (an example of the controller) and transmits a response including the results of the rerun to the distributor 122 (step S203).

The distributor 122 notifies that rerunning of an operation has been designated from among the operation history and the designated operation has been rerun to the history analyzer 121 (step S204). The history analyzer 121 records history information which indicates that the file to be operated has been rerun in a file (e.g., in “operate.xml” in the “tmp” folder) (step S205). The information recorded in this file (“operate.xml”) may be displayed in the “History of Rerun Past Operations” tab of the conference history list screen.

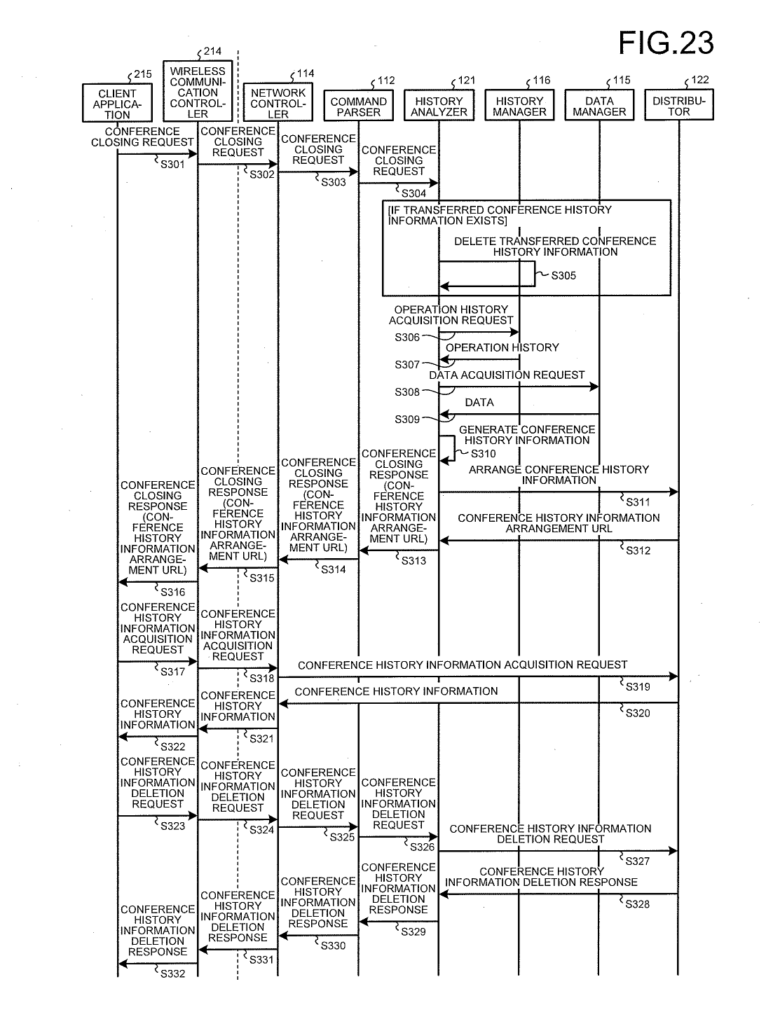

Next, conference closing processing performed at the time of closure of a conference will be described below. FIG. 23 is a sequence diagram which illustrates an example of the conference closing processing. The conference closing processing is performed when a “Close” button on the conference operation screen 1401 illustrated in FIG. 14 is pressed, for example.

The client application 215 of the information terminal 30 transmits a request for closing the conference to the information processing server 10 (step S301). The closing request is transmitted to the history analyzer 121 via the wireless communication controller 214 of the information terminal 30, the network controller 114 of the information processing server 10, and the command parser 112 (steps S302 to S304).

The history analyzer 121 deletes the transferred conference history information when the closing request is received (step S305). For example, the history analyzer 121 deletes the conference history information transferred from the information terminal 30 from a folder for storing temporarily generated data (for example, the “tmp” folder). It is also useful if the history analyzer 121 delete all the data from the folder for storing temporarily generated data. The developed conference history information is thus deleted from the information processing server 10. Note that if past conference history information has not been transferred from the information terminal 30, the history analyzer 121 may skip the deletion processing in step S305.

The history analyzer 121 acquires necessary information from the conference information database 119 (the data manager 115) and the history information database 117 (the history manager 116) to generate conference history information about the closed conference. For example, the history analyzer 121 issues a request for acquiring the operation history information to the history manager 116 (step S306). Upon receiving of the request, the history manager 116 transmits the operation history information about the closed conference to the history analyzer 121 (step S307). In addition, the history analyzer 121 issues a request for acquiring data such as conference information and image data to the data manager 115 (step S308). Upon receiving of the request, the data manager 115 transmits data such as the conference information about the closed conference and the used image data to the history analyzer 121 (step S309).

The history analyzer 121 generates conference history information from each piece of acquired information (step S310). The processing for generating conference history information (conference history generation processing) will be described in detail later below. The history analyzer 121 issues a request for arranging the generated conference history information so that it can be distributed to the distributor 122 (step S311). The distributor 122 arranges the conference history information so that it can be distributed to the information terminal 30 and the like. For example, the distributor 122 generates a web page from which the conference history information can be downloaded from the information terminal 30 on the web server. The distributor 122 transmits address information about the arranged conference history information (i.e., the URL of the web page or the like) to the history analyzer 121 (step S312).

The history analyzer 121 returns a response including the address information about the conference history information (conference closing response) to the client application 215. The conference closing response is transmitted to the client application 215 via the command parser 112, the network controller 114, and the wireless communication controller 214 (steps S313 to S316).

The client application 215 issues a request for acquiring the conference history information to the information processing server 10 by designating address information included in the conference closing response (step S317). The request is transmitted to the distributor 122 via the wireless communication controller 214 and the network controller 114 (steps S318 to S319).

The distributor 122 transmits the conference history information corresponding to the designated information to the client application 215 via the network controller 114 and the wireless communication controller 214 (steps S320 to S322). The client application 215 stores the transmitted conference history information to a storage device such as the HDD 204. The stored conference history information is used as the conference history information transmitted in step S109, for example.

After acquiring the conference history information, the client application 215 issues a request for deleting the conference history information to the information processing server 10 (step S323). The deletion request is transmitted to the distributor 122 via the wireless communication controller 214, the network controller 114, the command parser 112, and the history analyzer 121 (step S324 to S327). The client application 215 may include a passcode in the deletion request. With the above-described configuration, it is enabled to uniquely identify and delete the conference history information corresponding to the passcode present in the information processing server 10.

The distributor 122 deletes the designated conference history information and transmits a response including the result of the deletion (conference history information deletion response) to the client application 215 (step S328). The response is transmitted to the client application 215 via the history analyzer 121, the command parser 112, the network controller 114, and the wireless communication controller 214 (steps S329 to S332).

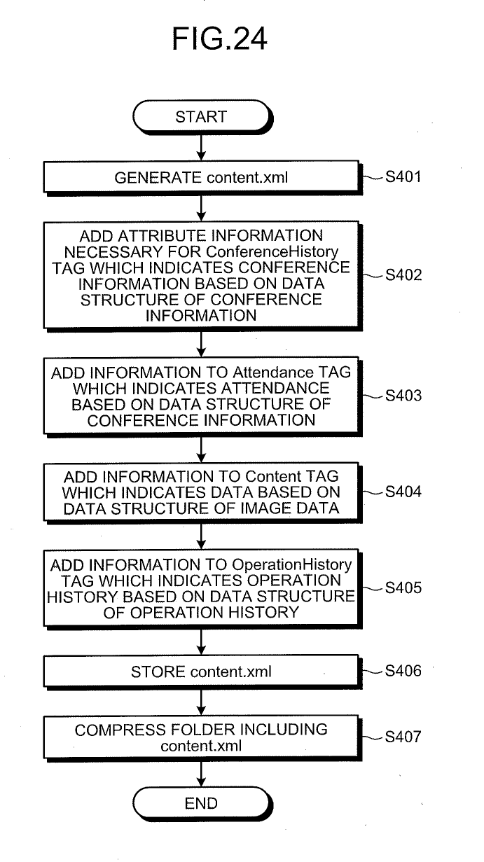

Next, the conference history generation processing (step S310 in FIG. 23) will be described in detail. FIG. 24 is a flow chart which illustrates an example of the conference history generation processing. In the conference history generation processing, the history analyzer 121 generates a file “content.xml” with the structure illustrated in FIG. 9, for example. The information to be included in the file is acquired in steps S306 to S309 illustrated in FIG. 23.

The history analyzer 121 newly generates a file “content.xml” to be used for analyzing the conference history information (step S401). The history analyzer 121 acquires attribute information necessary for a “ConferenceHistory” tag, which indicates conference information, from the acquired conference information and adds the acquired attribute information to the tag (step S402). The history analyzer 121 acquires information necessary for an “Attendance” tag, which indicates the attendance, from the acquired conference information and adds the acquired information to the tag (step S403). The history analyzer 121 adds information necessary for a “Content” tag, which indicates data, based on the arrangement of the acquired image data (step S404). The history analyzer 121 acquires information necessary for an “OperationHistory” tag, which indicates the operation history, from the acquired operation history information and adds the acquired information to the tag (step S405).

After adding the necessary information, the history analyzer 121 stores the file “content.xml” (step S406). The history analyzer 121 compresses the folder storing the stored file “content.xml” and the acquired image data to generate conference history information (step S407). For example, the history analyzer 121 compresses the file “content.xml” and the image data so that they are provided with the data structure illustrated in FIG. 8 and generates a compressed file (for example, “Conference-10-01-2015-1000-1100-5678.zip”)

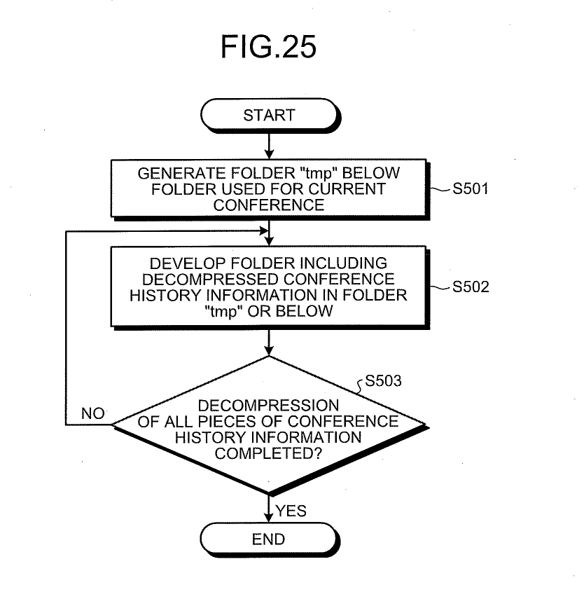

Next, the conference history development processing will be described below. FIG. 25 is a flow chart which illustrates an example of the conference history development processing. The conference history development processing is processing for developing (decompressing) compressed conference history information performed when the conference history information is transferred from the client application 215 to the information processing server 10. The conference history development processing corresponds to the processing performed in step S113 in FIG. 13, for example.

The history analyzer 121 generates a folder for temporarily storing data (for example, a folder “tmp”) in a folder used for the current conference (step S501). The history analyzer 121 develops a folder in which compressed conference history information has been decompressed in the generated folder (step S502). The history analyzer 121 determines whether decompression of all pieces of conference history information has been completed (step S503). If the decompression has not been completed yet (No in step S503), then the processing returns to step S502 to repeat the processing. If the decompression has been completed (Yes in step S503), the conference history development processing ends.

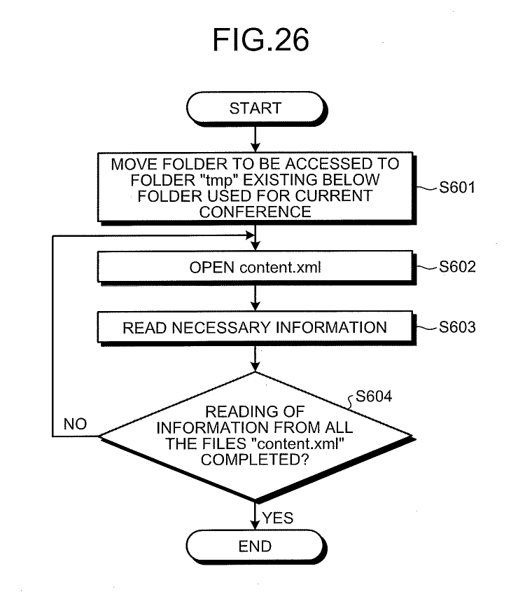

Next, the conference history analysis processing will be described. FIG. 26 is a flow chart which illustrates an example of the conference history analysis processing. The conference history analysis processing is processing for extracting (acquiring) information necessary for generating the web page for displaying the conference history list screen from the file “content.xml”, for example. The conference history analysis processing corresponds to the processing performed in step S122 in FIG. 13, for example.

The history analyzer 121 moves a folder to be accessed to the folder “tmp” in the folder used for the current conference (step S601). The history analyzer 121 opens the file “content.xml” stored in the moved folder (step S602). The history analyzer 121 reads information necessary for generating the conference history list screen from the file “content.xml” (step S603). For example, the history analyzer 121 reads conference information (e.g., the “ConferenceHistory” tag), attendance information (e.g., the “Attendance” tag), data (e.g., the “Content” tag), and operation history information (e.g., the “OperationHistory” tag).

The history analyzer 121 determines whether reading of information from all the files “content.xml” has been completed (step S604). If the reading has not been completed yet (No in step S604), the processing returns to step S602 and is repeated for a next file. If the reading has been completed (Yes in step S604), the conference history analysis processing ends.

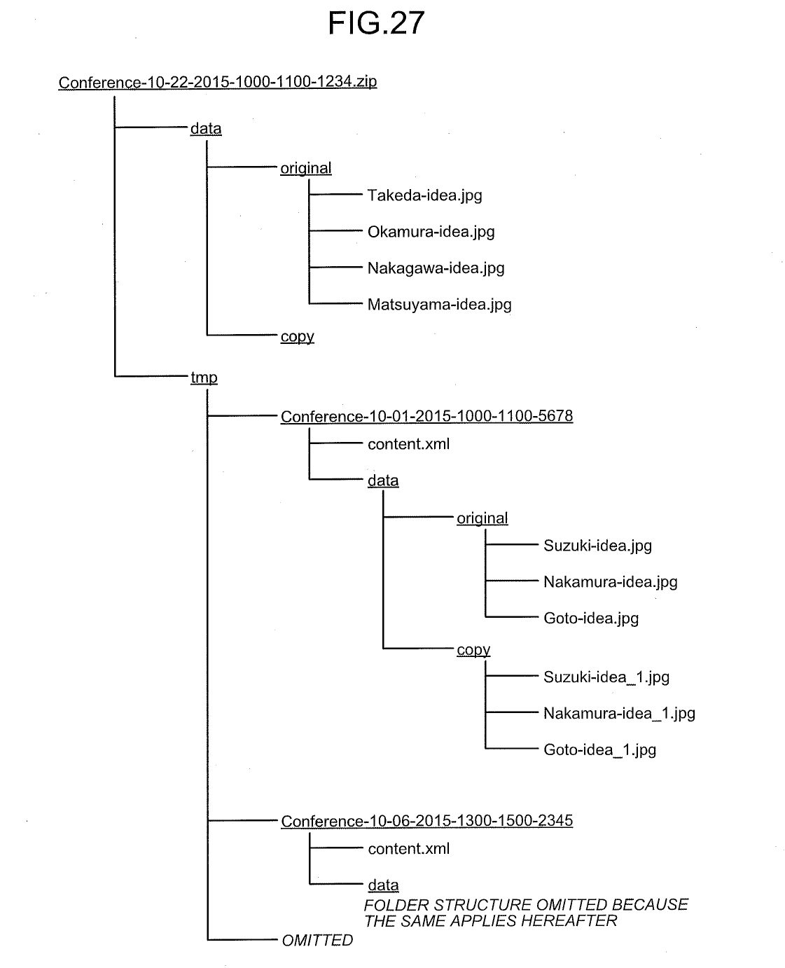

Next, examples of the folder structure after respective processing will be described. FIG. 27 is a view which illustrates an example of a folder structure after the conference history development processing. The developed conference history information is arranged in the folder “tmp” or below in the data folder for the current conference (“Conference-10-22-2015-1000-1100-1234”). In FIG. 27, an example is illustrated in which two folders (“Conference-10-01-2015-1000-1100-5678” and “Conference-10-06-2015-1300-1500-2345”) corresponding to two pieces of past conference history information are developed. If any conference history information other than them exist, the other conference history information is developed in the “tmp” folder or below in a similar manner.

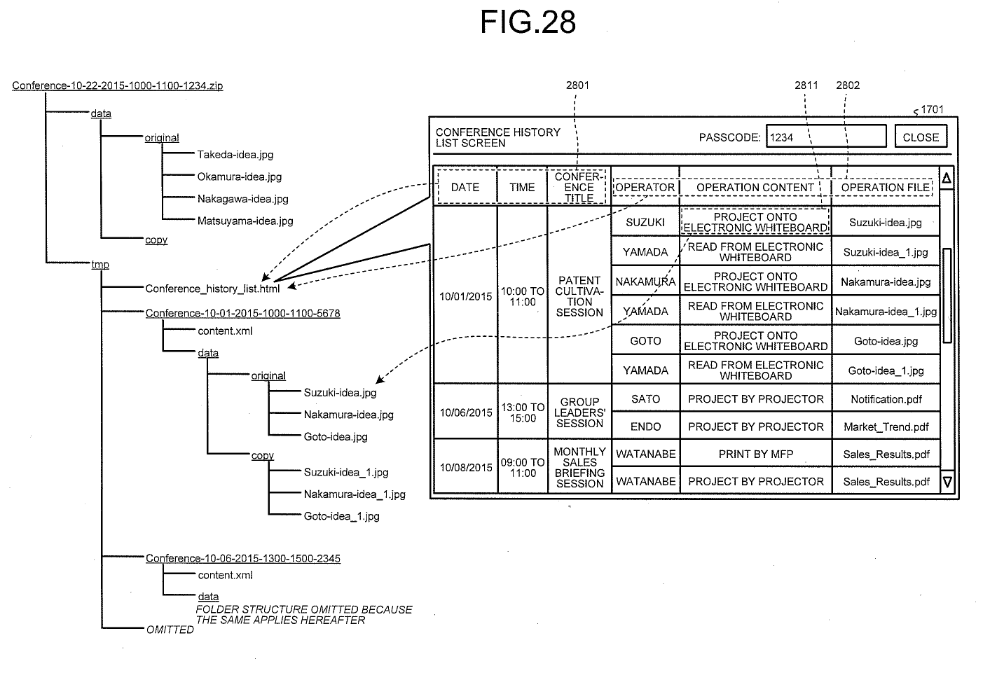

FIG. 28 is a view which illustrates an example of a folder structure after the conference history list screen has been generated. After the conference history list screen is generated, a file which indicates the web page for displaying this conference history list screen (“Conference_history_list.html”) is generated below the folder “tmp”. In this web page, the conference information, data, and operation history information read by the conference history analysis processing from the file “content.xml” are respectively mapped to respective corresponding data areas. For example, data areas 2801 and 2802 correspond to conference information and operation history information, respectively.

A link 2811 is a link for accessing corresponding data (“./Conference-10-01-2015-1000-1100-5678/data/original/Suzuki-idea.jpg”). The above-described link is included in the file for the web page (“Conference_history_list.html”). With the above-described configuration, it is enabled to notify a file pass for the data to be operated to the job manager 113 if rerunning of an operation has been designated.

As described above, if deletion of transferred conference history information has been designated, the history analyzer 121 may delete all data stored in the folder “tmp” or below.

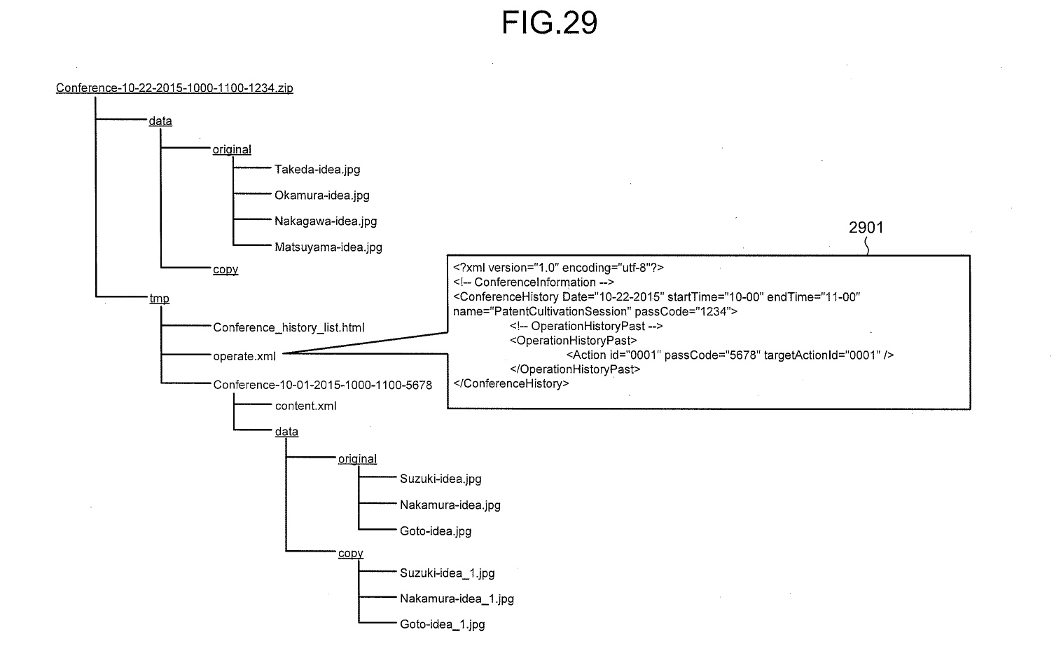

FIG. 29 is a view which illustrates an example of a folder structure after past operation history has been rerun. As described above, the history analyzer 121 generates a file in which history information which indicates that the rerun has been performed is recorded (“operate.xml”) in the folder “tmp” or below. A file 2901 denotes an example of the data structure of the file “operate.xml”. The file “operate.xml” is generated in the folder “tmp” or below, and thus if a configuration is employed in which data stored in the “tmp” folder and below are deleted at once, the file “operate.xml” is deleted together with other data. Accordingly, the conference history information generated at the time of closure of the current conference does not include operation history if past operation history has been rerun. As a result, the distributor 122 transmits conference history information including shared information shared for the current conference other than the shared information included in the transferred past conference history information at the time of closure of the current conference.

Note that the above embodiment does not limit the scope of the present invention and various system configurations can be employed in accordance with the purpose of use and the object. For example, the information terminal 30 may include a part of the functions included in the information processing server 10, and the information processing server 10 may include a part of the functions included in the information terminal 30. The information processing server 10 may be constituted by a plurality of physical devices. In this configuration, any of the plurality of physical devices may be provided with any function of the information processing server 10.

Note that the programs executed by the apparatuses of the present embodiment (the information processing server, the information terminal) are provided in such a manner that they are previously incorporated in a ROM and the like.

The programs executed by the apparatuses of the present embodiment may be provided as computer program products produced by recording them onto a computer-readable recording medium such as a compact disc-read only memory (CD-ROM), a flexible disc (FD), a compact disc-recordable (CD-R), and a digital versatile disk (DVD) as a file with a format that can be installed thereto or executed therefrom.

Further, another configuration may be employed in which the programs executed by the apparatuses of the present embodiment are stored on a computer connected to a network such as the Internet and provided by downloading them via the network. In addition, another configuration may be employed in which the programs executed by the apparatuses of the present embodiment are provided or distributed via a network such as the Internet.

The programs executed by the apparatuses of the present embodiment are configured as modules including the above-described units, and the programs are, as actual hardware, configured so that the respective units are loaded by the CPU (processor) by reading and executing the programs from the ROM onto a main storage and the respective units are generated on the main storage.

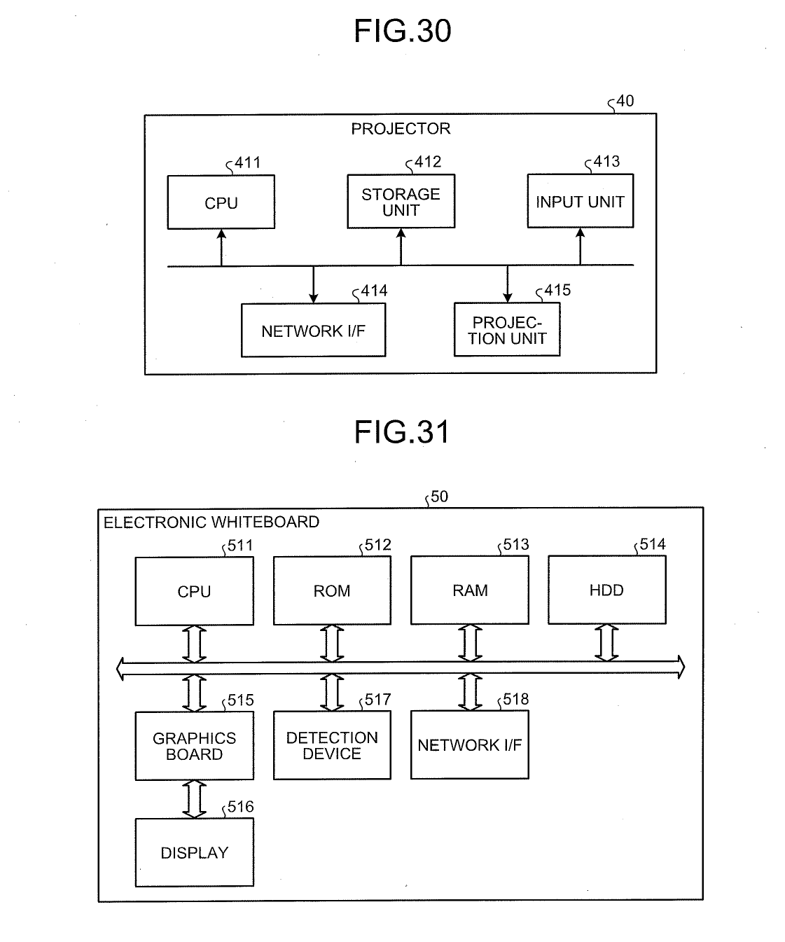

FIG. 30 is a schematic diagram which illustrates an example of a hardware configuration of the projector 40. Referring to FIG. 30, the projector 40 includes a CPU 411, a storage unit 412, an input unit 413, a network I/F 414, and a projection unit 415, which are interconnected via a bus.

The CPU 411 executes a program stored in the storage unit 412 and controls operations of the projector 40. The storage unit 412 is constituted by a ROM and an HDD storing the program executed by the CPU 411 and data necessary for execution of the program, a RAM which functions as a work area for the CPU 411, and the like. The input unit 413 is used for performing various inputs to the projector 40 and includes a touch panel, key switches, and the like. The network I/F 414 is an interface for connecting the projector 40 to the network. The projection unit 415 projects image data of a subject to be projected onto a projection object such as a screen. The projection unit 415 includes a projection optical system such as projection lenses.

FIG. 31 is a schematic diagram which illustrates an example of a hardware configuration of the electronic whiteboard 50. Referring to FIG. 31, the electronic whiteboard 50 includes a CPU 511, a ROM 512, a RAM 513, a hard disk drive (HDD) 514, a graphics board 515, a display 516, a detection device 517, and a network I/F 518, which are interconnected via a bus.

The CPU 511 reads and executes the programs from the ROM 512, the HDD 514, and the like on the RAM 513 and controls operations of the electronic whiteboard 50. The graphics board 515 is an apparatus for processing rendering data to be rendered in the display 516, and includes a video RAM (VRAM) for storing graphic images and contact terminals for connection with the display 516. The display 516 is a display apparatus which displays the rendering data generated by the graphics board 515.

The detection device 517 is a detection device which detects contact or approach by an object. Examples of the detection device 517 include a touch panel which includes a capacitance sensor for detecting the capacitance which varies upon contact of an object (a finger, a stylus pen, or the like). When contact position coordinates or approach position coordinates are detected by the detection device 517, the graphics board 515 renders a drawing image (handwritten image) based on based on the detected contact position coordinates or approach position coordinates and superposes the rendered image onto the background image. The network I/F 518 is an interface for connecting the electronic whiteboard 50 to the network 70.

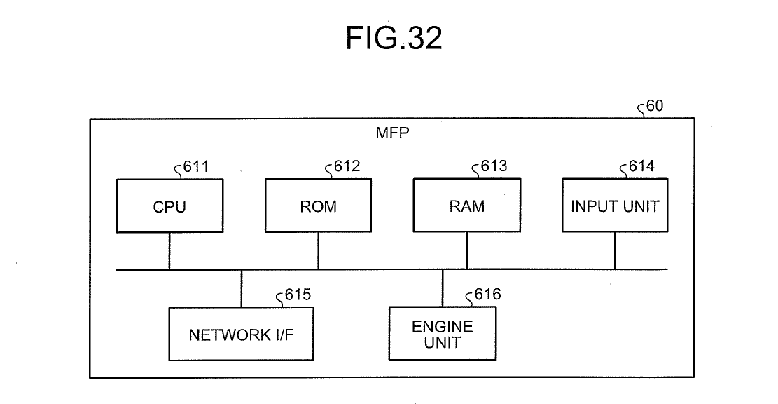

FIG. 32 is a schematic diagram which illustrates an example of a hardware configuration of the MFP 60. Referring to FIG. 32, the MFP 60 includes a CPU 611, a ROM 612, a RAM 613, an input unit 614, a network I/F 615, an engine unit 616, which are interconnected via a bus.

The CPU 611 reads and executes the programs from the ROM 612 and the like on the RAM 613 and controls operations of the MFP 60. The input unit 614 is used for performing various inputs to the MFP 60 and includes a touch panel, key switches, and the like. The network I/F 615 is an interface for connecting the MFP 60 to the network.

The engine unit 616 is hardware which performs general-purpose information processing and processing other than communication processing to implement a copy function, a scanner function, a facsimile function, and a printer function. For example, the engine unit 616 includes a scanner which scans and reads an image from an original document (image reading unit), a plotter which prints the read image onto a sheet material such as a paper sheet (image forming unit), and a facsimile unit which performs facsimile communication.

According to the present invention, an effect is exerted such that information to be shared can be easily identified.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus connected with a plurality of information terminals, comprising:
processing circuitry to
extract at least shared information from history information transmitted from a first information terminal included in the plurality of information terminals, the shared information being shared among at least two of the plurality of information terminals;
generate display information for displaying the extracted shared information; and
transmit the display information to at least one of the information terminals.

2. The information processing apparatus according to claim 1, wherein the processing circuitry is to
transmit history information including shared information shared among the plurality of information terminals to at least two of the information terminals having shared the shared information, and
extract the shared information from the history information having been transmitted to the first information terminal and transmitted from the first information terminal.

3. The information processing apparatus according to claim 2, wherein the processing circuitry is to transmit history information including shared information shared among the plurality of information terminals other than the shared information included in the history information transmitted from the first information terminal.

4. The information processing apparatus according to claim 1, wherein the processing circuitry is to transmit the display information to the first information terminal.

5. The information processing apparatus according to claim 1, wherein the processing circuitry is to generate display information for further displaying at least one of an operation performed for the shared information and a thumbnail image of the shared information.

6. The information processing apparatus according to claim 5, wherein when the thumbnail image is designated not to be displayed, the processing circuitry is to generate display information for not displaying the thumbnail image of the shared information.

7. The information processing apparatus according to claim 1, wherein
the processing circuitry is
to generate display information for further displaying operation performed for the shared information, and
further to perform, when the operation displayed according to the display information is designated to be performed, control for rerunning the designated operation.

8. The information processing apparatus according to claim 1, wherein the processing circuitry is to generate display information for further displaying an operation that can be performed for the shared information.

9. A system comprising:
a plurality of information terminals;
an information processing apparatus connected with the plurality of information terminals;
processing circuitry to
transmit history information including shared information shared among at least two of the plurality of information terminals to the information processing apparatus;
extract at least the shared information from the history information transmitted from the first information terminal included in the plurality of information terminals;
generate display information for displaying the extracted shared information; and
transmit the display information to at least one of the information terminals.

10. The system according to claim 9, wherein
the processing circuitry is to
transmit history information including shared information shared among the plurality of information terminals to at least two of the information terminals having shared the shared information, and
extract the shared information from the history information having been transmitted to the first information terminal and transmitted from the first information terminal.

11. The system according to claim 10, wherein the processing circuitry is to transmit history information including shared information shared among the plurality of information terminals other than the shared information included in the history information transmitted from the first information terminal.

12. The system according to claim 9, wherein the processing circuitry is to transmit the display information to the first information terminal.

13. The system according to claim 9, wherein the processing circuitry is to generate display information for further displaying at least one of an operation performed for the shared information and a thumbnail image of the shared information.

14. The system according to claim 13, wherein when the thumbnail image is designated not to be displayed, the processing circuitry is to generate display information for not displaying the thumbnail image of the shared information.

15. The system according to claim 9, wherein
the processing circuitry is
to generate display information for further displaying operation performed for the shared information, and
further to perform, when the operation displayed according to the display information is designated to be performed, control for rerunning the designated operation.

16. The system according to claim 9, wherein the generator generates display information for further displaying an operation that can be performed for the shared information.

17. An information processing method executed by a system including a plurality of information terminals and an information processing apparatus connected with the plurality of information terminals, the method comprising:
transmitting history information including shared information shared among at least two the plurality of information terminals;
extracting at least the shared information from the history information transmitted from a first information terminal included in the plurality of information terminals;
generating display information for displaying the extracted shared information; and
transmitting the display information to at least one of the information terminals.
